(19) United States
(12) Patent Application Publication
(10) Pub. No.: US 2013/0157022 A1
(43) Pub. Date: Jun. 20, 2013

(54) TRANSPARENT PANEL AND METHOD OF MANUFACTURING THE SAME

(71) Applicants: Woon Chun KIM, Suwon (KR); Kang Heon HUR, Seongnam (KR); Kyu Sang LEE, Suwon (KR)

(72) Inventors: Woon Chun KIM, Suwon (KR); Kang Heon HUR, Seongnam (KR); Kyu Sang LEE, Suwon (KR)

(73) Assignee: SAMSUNG ELECTRO-MECHANICS CO., LTD.

(21) Appl. No.: 13/619,093

(22) Filed: Sep. 14, 2012

(30) Foreign Application Priority Data
Dec. 16, 2011 (KR) 10-2011-0136355

(51) Int. Cl. H01B 13/00; B32B 27/06; B32B 17/06

(52) U.S. Cl. 428/212; 216/13

(57) ABSTRACT

There are provided a transparent panel and a method of manufacturing the same. The transparent panel includes a transparent substrate; and a transparent electrode layer formed on the transparent substrate, wherein the transparent electrode layer includes a first area having non-electrical conductivity and a second area having electrical conductivity, and the first area includes a graphene oxide, and the second area includes a reduced graphene oxide. Accordingly, a sensing electrode may be formed without a step to thereby minimize a pattern exposure phenomenon, and the manufacturing process may be simplified.

### CROSS-REFERENCE TO RELATED APPLICATIONS

This application claims the priority of Korean Patent Application No. 10-2011-0136355 filed on Dec. 16, 2011 in the Korean Intellectual Property Office, the disclosure of which is incorporated herein by reference.

### BACKGROUND OF THE INVENTION

1. Field of the Invention

The present invention relates to a transparent panel in which a transparent electrode is formed on a surface of a transparent substrate without a step, to minimize a pattern exposure phenomenon and simplify the manufacturing process thereof, and a method of manufacturing the transparent panel.

2. Description of the Related Art

A transparent panel is a device manufactured by forming an electrode having a predetermined pattern using a transparent conductive material having excellent light transmittance on a transparent substrate having excellent light transmittance. The transparent panel is widely used in flat panel displays (FPDs) such as a liquid crystal display (LCD) or an organic light emitting display (OLED) or an input device such as a touch screen. In particular, flat panel displays are currently provided as televisions for the home, and users of devices such as smartphones and navigation devices including a touch screen as an input device are increasing, such that demand for transparent panels is also increasing.

Methods of sensing a touch screen contact applied to electronic devices may be classified as a resistive method and a capacitive method. The capacitive method allows for a relatively long lifespan, and various types of intuitive input methods, and ease of movements during touch contact, and thus is increasingly being applied to electronic devices. In particular, as compared to the resistive method, it is easy to implement a multi-touch interface in the capacitive method, and thus it is being widely used in devices such as smartphones.

Touch screens using both the resistive method and the capacitive method include a transparent substrate and a transparent electrode formed on a surface of the transparent substrate. The transparent electrode may be formed by depositing a transparent conductive material such as indium-tin oxide (ITO), zinc oxide (ZnO), or indium-zinc oxide (IZO) on the surface of the transparent substrate using a sputtering method or the like, and etching the deposited transparent conductive material to have a desired pattern. However, in this case, there are provided an area in which the transparent conductive material is formed and an area in which the transparent conductive material is removed on the surface of the transparent substrate, and thus, a pattern exposure phenomenon may be generated due to a difference in light transmittance and refractive indices between the transparent electrode and the transparent substrate.

### SUMMARY OF THE INVENTION

An aspect of the present invention provides a transparent panel in which a transparent electrode is formed without a step by forming a graphene oxide layer on a transparent substrate, forming an etching resist on a first area which is at least a portion of the graphene oxide layer, and then reducing a second area, apart from the first area, such that the second area may obtain electrical conductivity. Thus, a pattern exposure phenomenon may be minimized, and the manufacturing process of the transparent panel may be simplified.

According to an aspect of the present invention, there is provided a transparent panel, including: a transparent substrate; and a transparent electrode layer formed on the transparent substrate, wherein the transparent electrode layer includes a first area having non-electrical conductivity and a second area having electrical conductivity, and the first area includes a graphene oxide, and the second area includes a reduced graphene oxide.

The transparent electrode may have the same thickness in the first area and the second area.

The transparent substrate may be a cover lens receiving a touch applied to at least one surface thereof.

The transparent substrate may include at least one of tempered glass, polycarbonate (PC), polyimide (PI), polyethylene terephthalate (PET), and polymethymethacrylate (PMMA).

According to another aspect of the present invention, there is provided a method of manufacturing a transparent panel, the method including: preparing a transparent panel; forming a graphene oxide layer on the transparent panel; providing an etching resist on a first area corresponding to a portion of the graphene oxide layer; and reducing a second area of the graphene oxide layer other than the first area.

The etching resist may have acid resistance.

The reducing of the second area may include reducing the second area using a gaseous or liquid reducing agent including at least one of iodic acid (HI), ammonia (NH₃), sodium hydroxide (NaOH), potassium hydroxide (KOH), hydrogen sulfide, hydrazine, and aluminum powder.

The providing of the etching resist may be performed by forming a photoresist on the first area.

The providing of the etching resist may be performed by laminating a dry film resist (DFR) on the first area.

The forming of the graphene oxide layer may be performed by at least one of a gravure coating method, a slot die coating method, and a spray coating method.

The method may further include removing the etching resist from the first area.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an exterior of an electronic device including a transparent panel according to an embodiment of the present invention;

FIG. 2 illustrates a touch screen including a transparent panel according to an embodiment of the present invention;

FIGS. 3A and 3B are cross-sectional views illustrating the touch screen illustrated in FIG. 2;

FIG. 4 is a flowchart illustrating a method of manufacturing a transparent panel according to an embodiment of the present invention; and

FIG. 5 is a schematic view for explaining a method of manufacturing a transparent panel according to an embodiment of the present invention.

### DETAILED DESCRIPTION OF THE EMBODIMENTS

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and scope of the present invention. In addition, it should be understood that positions and arrangements of individual components in each embodiment may be changed without departing from the spirit and scope of the present invention. Therefore, a detailed description provided below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

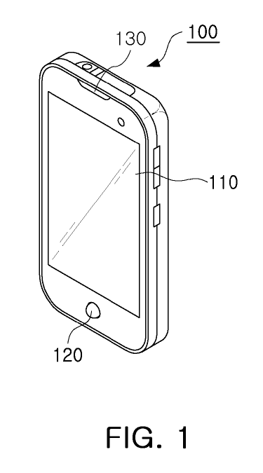

FIG. 1 is a perspective view of an exterior of an electronic device to which a touch sensing device according to an embodiment of the present invention is applicable. Referring to FIG. 1, an electronic device 100 according to the present embodiment of the invention may include a display device 110 for outputting an image, an input unit 120, an audio unit 130 for outputting audio, and a touch sensing device integrated with the display device 110. In this case, a transparent panel according to an embodiment of the present invention may be applied not only to the display device 110 but also to a touch screen-type touch sensing device.

As illustrated in FIG. 1, in the case of a mobile apparatus, the touch sensing device is generally provided integrally with the display device and needs to have high light transmittance enough to transmit the image displayed by the display device. Accordingly, the touch sensing device may be implemented by forming a sensing electrode using a transparent and electrically conductive material such as indium-tin oxide (ITO), indium zinc oxide (IZO), zinc oxide (ZnO), carbon nano tube (CNT), or graphene, on a base substrate formed of a transparent film material such as polyethylene terephthalate (PET), polycarbonate (PC), polyethersulfone (PES), polyimide (PI), or the like. The display device may include a wiring pattern disposed in a bezel area thereof, and the wiring pattern is connected to the sensing electrode formed of the transparent conductive material. Since the wiring pattern is visually shielded by the bezel area, the wiring pattern may be formed of a metallic material such as silver (Ag), copper (Cu), or the like.

The transparent panel according to the present embodiment may be formed by forming a graphene oxide layer on at least a surface of a transparent substrate and selectively reducing only a portion of the graphene oxide. The graphene oxide may be mixed with water or an organic solvent and be easily applied to at least one surface of the transparent substrate in the form of a dispersion solution. As the graphene oxide has electrical conductivity only in the selectively reduced portion, it may function as a transparent electrode.

Hereinafter, for convenience of explanation, description will be provided by assuming that the transparent panel according to the present embodiment is applied to a touch screen. However, the description does not limit the applications of the transparent panel, and the transparent panel according to the present embodiment may also be applied to various devices other than touch screens.

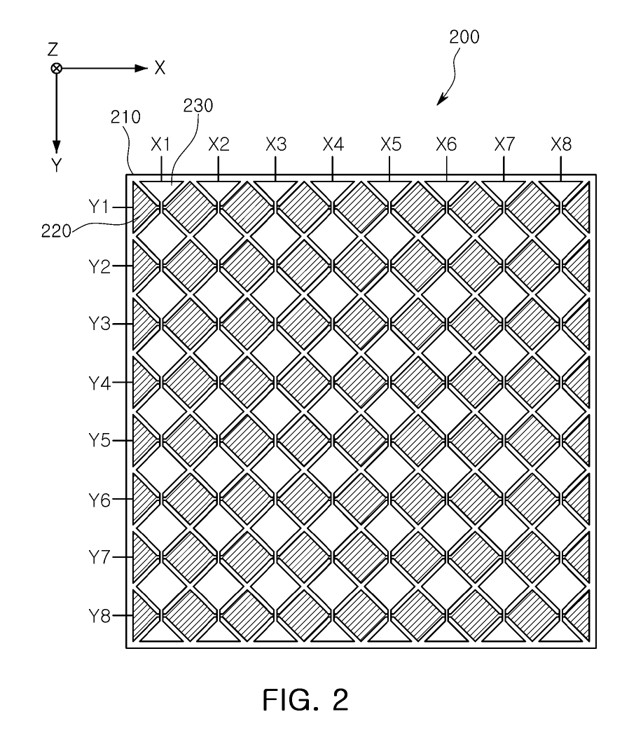

FIG. 2 illustrates a touch screen including a transparent panel according to an embodiment of the present invention. A touch screen 200 illustrated in FIG. 2 includes a transparent substrate 210 and a plurality of sensing electrodes 220 and 230 formed on the transparent substrate 210. The plurality of sensing electrodes 220 and 230 may include first electrodes 220 for sensing a touch in a Y-axis direction and second electrodes 230 for sensing a touch in an X-axis direction. Referring to FIG. 2, it is assumed that the eight first electrodes 220 and the eight second electrodes 230 are provided and the first electrodes 220 and the second electrodes 230 are connected to sensing channels Y1 to Y8 and X1 to X8 of a controller chip, respectively.

Referring to FIG. 2, the first electrodes 220 and the second electrodes 230 are illustrated as being formed on the same plane of the transparent substrate 210 for convenience of illustration; however, the first electrodes 220 and the second electrodes 230 may also be formed separately on upper and lower surfaces of the transparent substrate 210, or on a plurality of transparent substrates 210. That is, the touch screen 200 of FIG. 2 is merely an example for describing the transparent panel according to the embodiment of the present invention, and the transparent panel according to the present embodiment may also be included in touch screens having different structures from that of the touch screen 200 illustrated in FIG. 2.

Referring to FIG. 2, the plurality of sensing electrodes 220 and 230 are formed on the transparent substrate 210, and the sensing electrodes 220 and 230 are patterned such that predetermined shapes are repeated. Referring to FIG. 2, the sensing electrodes 220 and 230 are patterned such that the unit electrodes having a rhombus or diamond-shaped pattern are continuously connected to one another in the X-axis or Y-axis direction. According to the present embodiment of the invention, a graphene oxide layer is formed on a surface of the transparent substrate 210, and a portion of the graphene oxide layer is reduced by using a gaseous or liquid reducing agent to allow for electrical conductivity, whereby the sensing electrodes 220 and 230 having the pattern illustrated in FIG. 2 may be formed.

As shown in FIG. 2, the first electrodes 220 for sensing the position of the touch on the Y-axis and the second electrodes 230 for sensing the position of the touch on the X-axis may be arranged such that the plurality of the second electrodes 230 fill empty areas between the plurality of first electrodes 220 and the plurality of first electrodes 220 fill empty areas between the plurality of second electrodes 230. Thus, a first graphene oxide layer used to form the plurality of first electrodes 220 is reduced with the exception of areas thereof in which the plurality of second electrodes 230 are formed, thereby obtaining electrical conductivity. On the other hand, a second graphene oxide layer used to form the plurality of second electrodes 230 is reduced with the exception of areas thereof in which the plurality of first electrodes 220 are formed, thereby obtaining electrical conductivity.

In general, in a device including a transparent panel such as a touch screen, transparent electrodes are formed on a transparent substrate by forming a transparent conductive material on a surface of the transparent substrate by sputtering, and then removing the transparent conductive material therefrom, with the exception of portions thereof allowing for a desired shape (pattern), by etching. However, in this case, steps are necessarily formed between the transparent electrodes and the portions in which the transparent electrodes are not formed by the etching process of removing the transparent conductive material. Here, an area of the transparent substrate from which the transparent electrodes are removed may be damaged by a chemical etching process. Further, in the case in which the transparent electrodes may not be properly removed in the etching process, and problems such as a short circuit between the electrodes, which are to be electrically separated from each other, may occur.

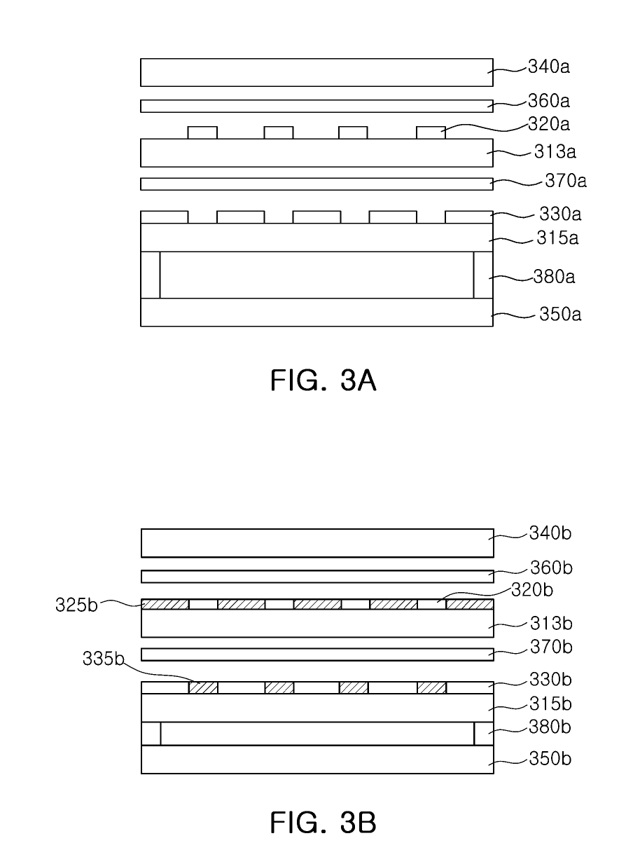

FIGS. 3A and 3B are cross-sectional views of the touch screen of FIG. 2. FIG. 3A is a cross-sectional view of a touch screen using a transparent panel manufactured by a general manufacturing method, and FIG. 3B is a cross-sectional view of a touch screen using a transparent panel according to an embodiment of the present invention.

Referring to FIG. 3A, a cover lens 340a, a first transparent adhesive layer 360a, a first transparent substrate 313a, a second transparent adhesive layer 370a, a second transparent substrate 315a, a gasket adhesive portion 380a, and a display device 350a are sequentially stacked. First and second sensing electrodes 320a and 330a are formed on the first and second transparent substrates 313a and 315a, respectively, thereby forming first and second transparent panels. The first and second transparent adhesive layers 360a and 370a may have excellent light transmittance such as an optical clear adhesive (OCA).

The display device 350a may be a flat panel display device but is not limited thereto. The display device 350a is attached to a lower substrate of a touch screen—the second transparent substrate 315a of FIG. 3A—using the gasket adhesive portion 380a or the like. The gasket adhesive portion 380a may be disposed at edges of the display device 350a, and an air gap is formed in an area in which the gasket adhesive portion 380a is not provided, between the display device 350a and the second transparent substrate 315a. The air gap may alleviate a phenomenon that electrical noise generated in the display device 350a is transmitted to the first and second sensing electrodes 320a and 330a to hinder the determination of the touch.

In the touch screen of FIG. 3A, the first and second sensing electrodes 320a and 330a formed on the first and second transparent substrates 313a and 315a may be formed of a transparent conductive material such as ITO, IZO, or ZnO. Also, as illustrated in FIG. 3A, the transparent conductive material is completely removed, using an etching process or the like, with the exception of an area in which the first and second sensing electrodes 320a and 330a are to be formed. Thus, a difference in thickness between the area in which the first and second sensing electrodes 320a and 330a are formed and the remaining area, that is, a step is generated.

The step between the first and second sensing electrodes 320a and 330a and the first and second transparent substrates 313a and 315a may increase a failure rate of a manufacturing process or may increase the possibility of the pattern exposure phenomenon of the first and second sensing electrodes 320a and 330a. It is known that the pattern exposure phenomenon of the first and second sensing electrodes 320a and 330a due to the step may be alleviated by the first and second adhesive layers 360a and 370a. However, in the case of a window-integrated touch screen in which the sensing electrodes 320a and 330a are directly formed on a surface of the cover lens 340a, additional transparent adhesive layers 360a and 370a are not disposed between the cover lens 340a and the sensing electrodes 320a and 330a, and thus it is difficult to prevent the pattern exposure phenomenon.

In addition, in a chemical etching process for forming the first and second sensing electrodes 320a and 330a, the remaining area of the first and second transparent substrates 313a and 315a in which the first and second sensing electrodes 320a and 330a are not formed may be damaged physically or chemically. This may cause scratches on the surfaces of the first and second transparent substrates 313a and 315a to increase a haze, thereby deteriorating transmittance and intensifying the pattern exposure phenomenon of the first and second sensing electrodes 320a and 330a.

FIG. 3B is a cross-sectional view of a stack structure of a touch screen to which a transparent panel according to an embodiment of the present invention is applied. Referring to FIG. 3B, a cover lens 340b, a first transparent adhesive layer 360b, a first transparent substrate 313b, a second transparent adhesive layer 370b, a second transparent substrate 315b, a gasket adhesive portion 380b, and a display device 350b are sequentially stacked. The stacking order is similar to that of FIG. 3A, except that first and second sensing electrodes 320b and 330b are respectively formed on first and second transparent substrates 313b and 315b without a step.

A graphene oxide layer is formed on the separate first and second transparent substrates 313b and 315b by applying a graphene oxide a spray coating method, a slot die coating method, a gravure coating method or the like, and an etching resist is only formed on first areas 325b and 335b corresponding to portions of the graphene oxide layer. A graphene oxide refers to a liquid insulation solution prepared by melting a solid-type graphite material in water or other organic solvent. The graphene oxide has excellent dispersibility, and thus may be easily applied to the first and second transparent substrates 313b and 315b.

When the etching resist is formed on the first areas 325b and 335b of the graphene oxide layer, the entirety of the graphene oxide layer is reduced using a predetermined reducing agent. Examples of the reducing agent include at least one of iodic acid, ammonia (NH₃), sodium hydroxide (NaOH), potassium hydroxide (KOH), hydrogen sulfide, hydrazine, and aluminum powder. The etching resist function as a shield so that the first areas 325b and 335b of the graphene oxide layer are not reduced by the reducing agent, and thus the etching resist may be formed of a material having acid resistance so as not to be melted by acid.

By reducing the graphene oxide layer, on which the etching resist is formed, using a reducing agent, the first areas 325b and 335b blocked from being in contact with the reducing agent due to the etching resist may have non-electrical conductivity as the properties of the graphene oxide. On the other hand, second areas, that is, the remaining areas with the exception of the first areas 325b and 335b, are reduced by the reducing agent to thereby obtain electrical conductivity. Accordingly, the first and second sensing electrodes 320b and 330b are formed in the second areas by a reduction process without a chemical etching or washing process. Also, no step is formed between the second areas having electrical conductivity in which the first and second sensing electrodes 320b and 330b are formed and the first areas 325b and 335b having non-electrical conductivity, as illustrated in FIG. 3B.

That is, the graphene oxide is formed on the first and second transparent substrates 313b and 315b regardless of whether they have electrical conductivity or non-electrical conductivity. Thus, compared to the embodiment illustrated in FIG. 3A, a difference between a refractive index of the second areas in which the first and second sensing electrodes 320b and 330b are formed and a refractive index of the first areas 325b and 335b having non-electrical conductivity is decreased. Consequently, the pattern exposure phenomenon of the first and second sensing electrodes 320b and 330b may be alleviated. The transparent panel manufactured by the above-described method may be advantageous when being applied to a window-integrated touch screen in which the sensing electrodes 320b and 330b are directly formed on the cover lens 340b.

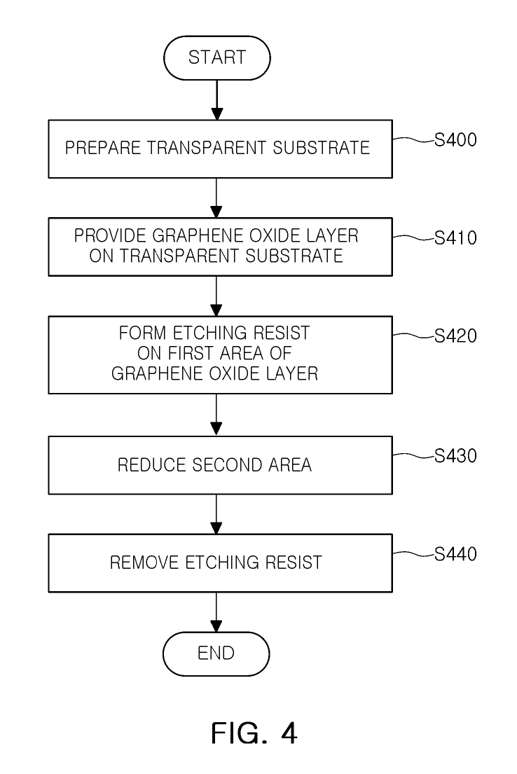

FIG. 4 is a flowchart illustrating a method of manufacturing a transparent panel according to an embodiment of the present invention.

Referring to FIG. 4, the method of manufacturing the transparent panel according to the present embodiment initiates with preparing a transparent substrate (S400). As described above, the transparent substrate may be an acrylic-based substrate formed of polyethylene terephthalate (PET), polycarbonate (PC), polyethersulfone (PES), polyimide (PI), polymethymethacrylate (PMMA) or the like, or a window substrate formed of tempered glass or the like. A graphene oxide layer is formed on the transparent substrate (S410).

The graphene oxide layer may be formed by applying a solution, in which a solid-type graphite is diluted in water or an organic solvent, to the transparent substrate by a gravure coating method, a slot die coating method, a spray coating method or the like. The graphene oxide solution has excellent dispersibility, and thus it is easy to form the graphene oxide layer on the transparent substrate. In addition, the graphene oxide solution has non-electrical conductivity, that is, insulating properties.

After the graphene oxide layer is formed, an etching resist is formed on a first area corresponding to at least a portion of the graphene oxide layer (S420). The etching resist is formed on the first area of the graphene oxide layer intended to maintain its insulating properties without being reduced. Also, in order to prevent the first area from being reduced in the case that the etching resist is affected by a reducing agent including acid in a subsequent reducing process, the etching resist may have excellent acid resistance.

After the etching resist is formed on the first area of the graphene oxide layer, a second area, on which the etching resist is not formed, is reduced (S430). A gaseous or liquid reducing agent may be used in the reducing process, and as described above, at least one of iodic acid (HI), ammonia (NH₃), sodium hydroxide (NaOH), potassium hydroxide (KOH), hydrogen sulfide, hydrazine, and aluminum powder may be used therefor. When the reducing process is completed, the etching resist is removed (S440), and the manufacturing process of the transparent panel is completed.

After the above-described operations, the first area of the graphene oxide layer maintains the insulating properties of the graphene oxide, and only the second area is reduced to obtain electrical conductivity. Thus, a transparent electrode may be formed on the transparent substrate without a thickness difference or a step, and in particular, when the transparent panel is applied to a window-integrated touch screen in which a transparent substrate is directly used as a cover lens, a pattern exposure phenomenon may be minimized.

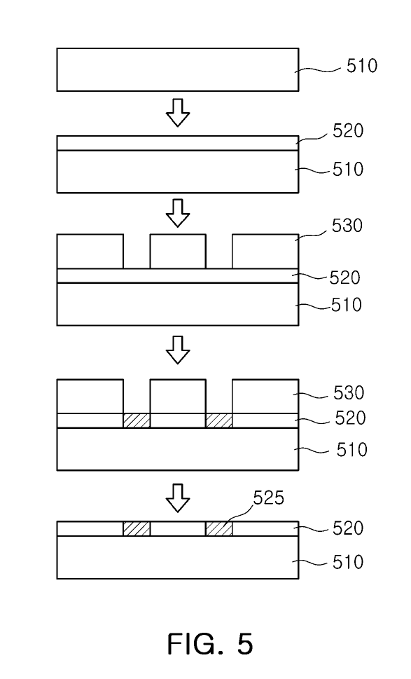

FIG. 5 is a schematic view for explaining a method of manufacturing a transparent panel according to an embodiment of the present invention.

Referring to FIG. 5, a transparent substrate 510 is prepared, and a graphene oxide layer 520 is formed thereon using a graphene oxide solution. As described above with reference to FIG. 4, the graphene oxide layer 520 may be formed by a gravure coating method, a slot die coating method, a spray coating method or the like. When the graphene oxide layer 520 is formed and the shape of transparent electrodes and an area in which the transparent electrodes are to be formed are specified on the graphene oxide layer 520, an etching resist 530 is formed on a first area of the graphene oxide layer 520.

The first area of the graphene oxide layer 520, on which the etching resist 530 is formed, corresponds to an area excepting for the transparent electrodes, the area in which the properties of a graphene oxide having non-electrical conductivity are maintained. When the graphene oxide layer 520 having the etching resist 530 formed thereon is reduced, only a second area 525 of the graphene oxide layer 520, which is not blocked by the etching resist 530 from being in contact with a reducing agent, is reduced to thereby obtain electrical conductivity.

After the reducing process, the etching resist 530 is removed to complete the manufacturing process of the transparent panel. As shown in FIG. 5, the first area 520 having non-electrical conductivity and the second area 525 having electrical conductivity of the graphene oxide layer 520 have the same thickness without a step. Accordingly, unlike general transparent panels formed by sputtering and etching, a difference in refractive indices of the transparent substrate 510 and the sensing electrode 525 does not affect visibility of the sensing electrode 525, and thus the pattern exposure phenomenon of the sensing electrode 525 may be minimized.

As set forth above, according to embodiments of the present invention, a graphene oxide layer is formed on at least a surface of a transparent substrate, and the graphene oxide layer includes a first area having non-electrical conductivity and a second area having electrical conductivity. Thus, a transparent electrode may be formed without a step, whereby a pattern exposure phenomenon may be alleviated while the manufacturing process of a transparent panel may be simplified.

While the present invention has been shown and described in connection with the exemplary embodiments, it will be apparent to those skilled in the art that modifications and variations can be made without departing from the spirit and scope of the invention as defined by the appended claims.

What is claimed is:

1. A transparent panel, comprising:
a transparent substrate; and
a transparent electrode layer formed on the transparent substrate,
wherein the transparent electrode layer includes a first area having non-electrical conductivity and a second area having electrical conductivity, and
the first area includes a graphene oxide, and the second area includes a reduced graphene oxide.

2. The transparent panel of claim 1, wherein the transparent electrode layer has the same thickness in the first area and the second area.

3. The transparent panel of claim 1, wherein the transparent substrate is a cover lens receiving a touch applied to at least one surface thereof.

4. The transparent panel of claim 1, wherein the transparent substrate includes at least one of glass, polycarbonate (PC), polyimide (PI), polyethylene terephthalate (PET), polyethersulfone (PES), and polymethymethacrylate (PMMA).

5. A method of manufacturing a transparent panel, the method comprising:
preparing a transparent substrate;
forming a graphene oxide layer on the transparent substrate;
providing an etching resist on a first area corresponding to a portion of the graphene oxide layer; and
reducing a second area of the graphene oxide layer other than the first area.

6. The method of claim 5, wherein the etching resist has acid resistance.

7. The method of claim 5, wherein the reducing of the second area comprises reducing the second area using a gaseous or liquid reducing agent including at least one of iodic acid (HI), ammonia (NH₃), sodium hydroxide (NaOH), potassium hydroxide (KOH), hydrogen sulfide, hydrazine, and aluminum powder.

8. The method of claim 5, wherein the providing of the etching resist is performed by forming a photoresist on the first area.

9. The method of claim 5, wherein the providing of the etching resist is performed by laminating a dry film resist (DFR) on the first area.

10. The method of claim 5, wherein the forming of the graphene oxide layer is performed by at least one of a gravure coating method, a slot die coating method, and a spray coating method.

11. The method of claim 5, further comprising removing the etching resist from the first area.
